(19) United States
(12) Patent Application Publication
(10) Pub. No.: US 2015/0294656 A1
(43) Pub. Date: Oct. 15, 2015

(54) METHOD AND SYSTEM FOR GENERATING SOUNDS USING PORTABLE AND INEXPENSIVE HARDWARE AND A PERSONAL COMPUTING DEVICE SUCH AS A SMART PHONE

(71) Applicant: Gregor Z. Hanuschak, Ardmore, PA (US)

(72) Inventor: Gregor Z. Hanuschak, Ardmore, PA (US)

(21) Appl. No.: 14/683,550

(22) Filed: Apr. 10, 2015

Related U.S. Application Data
(60) Provisional application No. 61/978,875, filed on Apr. 12, 2014.

(51) Int. Cl. G10G 7/00; G06F 3/041

(52) U.S. Cl. CPC G10G 7/00; G06F 3/041

(57) ABSTRACT

Disclosed is a method and system describing an electronic musical instrument which outsources processing, memory, and audio output functions to a personal computing device such as a smart phone in order to achieve an electronic musical instrument with minimal hardware components, minimal cost, and potential for high portability. In an embodiment, the electronic musical instrument can be as small as an individual sensor which can be removably attached to any surface, although the technology is such that the instrument could be shaped in nearly any shape or size desired.

### RELATED APPLICATIONS

This application claims priority to U.S. provisional application No. 61/978,875 entitled “METHOD AND SYSTEM FOR GENERATING SOUNDS USING PORTABLE AND INEXPENSIVE HARDWARE AND A PERSONAL COMPUTING DEVICE SUCH AS A SMART PHONE”, filed on Apr. 12, 2014, the contents of such application being incorporated by reference herein.

### BACKGROUND OF THE INVENTION

Musicians, particularly those that play electronic instruments, are constantly motivated to find and use new and unique sounds in their music. For those that play the electric guitar, common ways to get new sounds are to buy expensive amplifiers, distortion pedals, or processors. For those that play the electronic keyboard or electronic drum sets, common ways include buying expensive electronic hardware synthesizers. It would be advantageous for a musician to be able to have less expensive access to new sounds and even more advantageous if the new sounds were available nearly instantaneously, such that the musician would not have to purchase new electronic hardware every time he wanted new sound options.

Musicians who play electronic musical instruments can also face challenges when they wish to transport their instruments from place to place. In terms of portability, electronic keyboards can be quite heavy, electronic drum sets include multiple pieces, and electric guitars (as well as electronic keyboards and electronic drum sets) can be cumbersome, especially if a musician also must transport a heavy amplifier with him in addition to the instrument itself. The instruments are portable, but not easily portable. A need exists for an electronic instrument which does not require significant effort to transport from place to place.

Finally, electronic musical instruments are also expensive due to all the electronic components inside. It would also be desirable if an electronic instrument existed which did not require all these electronic components, thus driving down the overall cost of the instrument.

### SUMMARY OF THE INVENTION

For musicians who play electronic musical instruments, the discussed challenges can be partially addressed using personal computing devices. Personal computing devices such as smart phones, electronic tablets, and laptops have become quite common in our society. These devices are small, lightweight, and portable, yet are capable of both processing and storing ample amounts of data.

For accepting user input, a common element of personal computing devices is a user interface. The user interface of a personal computing device can take various forms including, without limitation, touchscreens, track balls, and keyboards. Many personal computing devices also include microphones and speakers and are capable of running software applications. These software applications can allow a user to record voice memos, play music files, access the internet, or even connect to other devices using Bluetooth technology.

Many musicians who would like to play electronic musical instruments also own a personal computing device. In accordance with an aspect of the present invention, there is provided a portable musical instrument which makes use of such a personal computing device. The overall portable musical instrument system includes, without limitation, both a personal computing device and an additional external user interface which is removably connectable to the personal computing device.

The external user interface is adapted for accepting additional user input from the musician. Although other embodiments may accept alternative forms of user input, the external user interface of the described portable musical instrument embodiment is adapted to accept tactile input from touch-sensitive sensors. In one embodiment, each of the touch-sensitive sensors are 1.3125″ width, 2.3125″ length ovals contained within their own mounting structures, however, without limitation, other embodiments are envisioned which accept tactile input from touch-sensitive sensors of alternative sensor sizes and shapes. Furthermore, these embodiments may just as easily place all touch-sensitive sensors within the same mounting structure or within two or more mounting structures.

A musician uses the portable musical instrument by applying pressure to the touch-sensitive sensors. When the musician applies pressure to a touch-sensitive sensor, a specific signal is sent to the musician's personal computing device. The signal can be sent to the personal computing device via a direct electrical connection or the signal can be sent wirelessly using a transmitter. In some embodiments, the signal is sent using a transmitter and the transmitter is a Bluetooth transmitter.

A signal which is sent to the personal computing device may contain, without limitation, information about the identity of the sensor which was activated. In some embodiments, the signal also contains information about the force at which the sensor was struck.

Upon receiving the signal from a touch-sensitive sensor, software resident on the personal computing device instructs the processor of the personal computing device how to respond. Each touch-sensitive sensor may have a specific sound associated with it and the same sound may be associated with more than one of the sensors. Sounds are digitally stored as sound files in the memory module of the personal computing device. If a received signal indicates that a touch-sensitive sensor was activated with a sound associated with it, the processor ensures that this sound is contained in the output audio produced by the personal computing device. If the received signal also indicates an approximation of the force at which the sensor was struck, the processor ensures that the resulting sound contained in the output audio has a volume level commensurate with that force. Thus, striking a sensor with greater intensity would result in a louder sound.

Playback of a sound is triggered and commences as soon as the personal computing device receives a signal from a sensor which has the sound assigned to it. Without limitation, triggered sounds may consist of musical sounds from a guitar, bass, keyboard, or another musical instrument. Triggered sounds may also consist of non-musical sounds such as animal sounds or human speech.

In addition, triggering a sensor does not have to produce a single sound. Without limitation, a sensor may also correspond to a sequence of sounds. Like individual sounds, sequences of sounds can also be mapped to any of the sensors and the same sequence of sounds may be mapped to more than one of the sensors. In some embodiments, a sequence of sounds has a louder volume associated with it if the sensor associated with that sequence is struck with greater intensity. Regardless of whether user activation of a sensor triggers a single sound or a sequence of sounds, the personal computing device's processor ensures that the assigned sound or sequence of sounds are included in the generated signal for playback whenever the corresponding sensor is activated.

In the case of the portable musical instrument, multiple sounds and multiple sequences can all be triggered concurrently if they are associated with different touch-sensitive sensors. However, in the rare case that the same sensor is triggered in rapid succession and the previous instance of the sound or sequence associated with that sensor has not yet completed playback before a subsequent instance is triggered, the previous instance cuts off where it left off and the subsequent instance is allowed to begin.

Mapping a sound or a sequence of sounds to a specific touch-sensitive sensor is a customization which the user can perform using the portable musical instrument's external user interface. Not all touch-sensitive sensors contained in the external user interface are meant to produce sounds and the software application resident on the personal computing device interprets the signals produced by some sensors as a request for alternative functionality. Such alternative functionality can include selection of a sound and assigning that sound to a sensor. Such alternative functionality can also include setting the order and timing of selected sounds to create a sequence of sounds and assigning that sequence to a sensor. A musician may select sounds from those already stored in the memory module or the musician may select new sounds, nearly instantaneously, from 1.) external media or an external memory module removably connected to an element of the portable musical instrument or 2.) an internet accessible server. The software application ensures that the connection is established with the external media, external memory module, or internet accessible server and, upon selection of a new sound, ensures the sound is downloaded to the memory module before its subsequent assignment to a sensor.

It may be beneficial to allow a musician to obtain near-instantaneous access to new sounds without needing to buy an expensive amplifier, distortion pedal, processor, or hardware synthesizer. Sounds found on the internet accessible server can come from anywhere, but most notably they come from the community of musicians who own portable musical instruments. Every musician in this community may also use touch-sensitive sensors to access the microphone of his personal computing device, record a sound, and upload the sound to the internet accessible server for use by one or more members of the community.

It may also be beneficial to allow a musician portable access to new sounds. The portable musical instrument allows the musician access to new sounds no matter where he is without requiring the musician to transport distortion pedals, processors, or hardware synthesizers with him in addition to his electronic instrument. The musician may still need to transport an amplifier (although not in the case of the vehicle-mounted musical instrument, to be described later), but the musician need not transport the amplifier as a source of providing new sounds. Instead, the musician may simply use an amplifier for a means to further amplify the volume of sounds (and his overall performance) in the general sense.

Musical performances produced by the portable musical instrument can exhibit great creativity and both the musician and those listening to the performance may wish to hear the same performance again at a later time. To allow for such future re-listening, the portable musical instrument can be used to make a recording of the musical performances, i.e. save an exact copy of the generated output audio. Without limitation, these recordings can be saved as audio files in a format readily playable on personal computing devices, such as MPEG Audio Layer III (mp3) format.

In some embodiments, the option to record output audio is provided to the musician using, once again, the external user interface. In the case of the portable musical instrument, a musician can indicate to the system when he wishes to commence and conclude recording his performance by activating one or more touch-sensitive sensors. In many embodiments, the external user interface can also be used to choose whether to save recordings to the memory module, to an internet accessible server, or to external media or an external memory module connected to an element of the portable musical instrument. The musician may upload the recordings to an internet accessible server in order to 1.) more quickly and easily share the musical performances with a wider audience or 2.) eliminate the need to keep a copy in the memory module and thus free up valuable storage space for other uses. The musician may also save a recording to external media or an external memory module in order to free up valuable storage space in the memory module. The external user interface can also be used to delete unwanted recordings from the memory module, internet accessible server, external media, or external memory module if the user wishes to do so.

The output audio produced by the personal computing device may contain more than just triggered sounds. The external user interface may be used to, without limitation, select background music to accompany the musician during his performance. If background music is selected, the output audio produced by the personal computing device would be composed of first, the background music and second, additional sounds corresponding to signals produced from triggered sensors at such times that those sounds are triggered by the sensors.

A musician may use the external user interface to select background music from multiple sources. Without limitation, background music may be stored in the memory module, can come from an internet accessible source, or can come from external media or an external memory module connected to an element of the portable musical instrument.

In the case of the portable musical instrument, background music stored in the memory module can take many forms. A musician may select music which was previously generated, recorded, and saved to the memory module, and hence, the musician can activate sensors to provide further instances of stored sounds above and beyond the sounds already present in the recording.

Furthermore, many personal computing devices are designed to store and play music files of popular recorded music. Without limitation, these music files are stored in mp3 format as mp3 music files. These mp3 music files are another type of background music from the memory module which a musician can choose to accompany his performance.

In addition to background music already stored in the memory module, selectable background music may also include, without limitation, music files downloaded from the internet, real-time streaming internet radio, and music files saved to external media or an external memory module connected to an element of the portable musical instrument. Note that music files downloaded from the internet, saved to external media, or saved to an external memory module might include music which was previously generated, recorded, and saved using the portable musical instrument. Also note that for music files downloaded from the internet and real-time streaming internet radio (as well as music files from external media or an external memory module connected to an element of the portable musical instrument), the music must be first downloaded to the memory module in order to perform digital mixing with the sensor-triggered sounds.

Without limitation, selected background music may take many different forms. The background music might not have full instrumentation, and might be more of a background rhythm to help keep a beat. On the other end of the spectrum, the background music might not include drum sounds. When using background music with an absence of drum sounds, one or more of the triggered audio sounds might be drum sounds such as those produced by a bass drum, tom drum, snare drum, cowbell, or cymbal from a standard drum kit, or any other such percussive instrument. Thus, in such an embodiment, the musician can activate sensors to provide a source of drum sounds in the output audio produced by the personal computing device.

Note that the external user interface may also be used to insert any form of selected background music into tracks in a playlist and, further, the external user interface may be used to navigate through that playlist to, without limitation, pause playing of a track, resume playing a track, fast forward through a track, skip to the next track, rewind through a track, or skip to the previous track.

Processing, i.e. adding audio effects to sounds, background music, and the output audio is also possible with the portable musical instrument. Personal computing devices are capable of performing the same processing (or, for analog electronics, at least reasonably modeling the same processing) provided by amplifiers, distortion pedals, processors, and hardware synthesizers. In some embodiments, initiating audio effects is yet another function of the external user interface. Such audio effects may include, without limitation, changes to the volume, equalization, panning, or pitch as well as manipulation using common audio effects such as reverb, delay, flange, chorus, compression, or distortion. In these embodiments, the external user interface allows user selection of processing effects and also accepts user inputs for setting key attributes of those processing effects. All such processing is performed by the processor and it should be noted that programming of a processor to perform such processing could be accomplished with minimal effort by someone skilled in the art.

Musicians may also use the portable musical instrument to collaborate on performances with other musicians who own portable musical instruments. Using the external user interface, one musician can designate his portable musical instrument as the “host device” and additional musicians can designate their portable musical instruments as “client devices”. Using a direct electrical connection or a wireless connection, the host device is removably connected to one or more client devices. In some embodiments, this removable connection is a bi-directional connection and both host and client devices may share sounds and background music, however in the case of the portable music instrument, the removable connection is uni-directional. In the case of the portable musical instrument, the host device provides all potential sounds and background music for the collaborative performance, although in alternative embodiments with a uni-directional connection, a client device may send the host device sounds or background music for use in in the performance.

To execute collaboration among portable musical instruments, the host device receives data from the client devices over the direct or wireless connection. This data includes, without limitation, information about what sound or sequence of sounds are currently associated with client device sensors, what processing (if any) is being performed on these sounds or sequences, which client device sensors have been activated by their users, and in some embodiments, information about the force at which client device sensors were struck. Upon activation of a touch-sensitive sensor, regardless of which device the sensor is associated with, the host device processor ensures that this sensor's assigned sound or sequence of sounds are included in the host device's generated signal for playback, complete with force-related volume data or any processing which may have been added to the sound or sequence of sounds. Note that for collaboration, the host device's generated signal for playback is the overall output audio for the entire system of host and client devices and, in the same way as solo performances, this overall output audio may be recorded and saved by the host device.

Other forms of collaboration between musicians may also occur, even if only one of the musicians is performing with a portable musical instrument. Through a direct or wireless connection, a microphone or electronic instrument may connect to the personal computing device of any portable musical instrument in the system, regardless of whether or not the device is a host device or client device. The portable musical instrument removably connected to the microphone or electronic instrument digitally mixes the performance it receives from the microphone or electronic instrument with the output audio of the device. In the case of multiple portable musical instruments, output audio from all client devices are sent to the host device to be mixed together to produce the overall output audio for the entire system of host and client devices. Once again, this overall output audio may be recorded and saved by the host device.

In some embodiments, the user interface of the personal computing device is also used to collect user input. In the case of the portable musical instrument, the personal computing device's user interface includes a keyboard with touch-sensitive sensors to accept user input however, without limitation, a personal computing device might also accept user input using track balls and virtual buttons on a touchscreen.

Without loss of generality, any of the discussed uses of the external user interface may be assigned to the personal computing device's user interface including, without limitation, using the personal computing device's touch-sensitive sensors to add sounds to the output audio; customizing which sounds or sequence of sounds are associated with each of the sensors; commencing or concluding the recording of a performance; selecting background music; adding background music to a playlist and manipulating that playlist; adding audio effects to sounds, background music, and the output audio; and connecting to another personal computing to share background music and collaborate on a performance. Any of the discussed uses may be concurrently performed by both the external user interface and the personal computing device's user interface, i.e., just because a particular function is performed by the external user interface doesn't mean the same function can't also be performed by the personal computing device's user interface. For example, the personal computing device's user interface can allow for customization in associating a sound with a sensor regardless of whether or not the sensor is located in the external user interface or the personal computing device's user interface.

Note that, when using a personal computing device's touch-sensitive sensors to add sounds to the output audio, it is still possible (in some embodiments) to receive information about the force at which a sensor was struck. For user interface sensors, this might be accomplished, without limitation, by approximating the force using one or more of the personal computing device's accelerometers (if present).

In accordance with an aspect of the present invention, there is also provided a vehicle-mounted musical instrument which makes use of a personal computing device. Details of this vehicle-mounted musical instrument can be found on Kickstarter.com (http://www.kickstarter.com/projects/smackattack/smack-attack-the-drum-set-for-your-steering-wheel). In this embodiment, the occupant of a vehicle generates sounds through interaction with touch-sensitive sensors located within a motor vehicle. In this embodiment, eight (8) touch-sensitive sensors are arranged in a substantially circular array and contained within three (3) mounting structures mounted on the motor vehicle's steering wheel. In this embodiment, an additional feature of the system is that information from any accelerometers contained within the personal computing device can be sent to the software application running on the processor and used to determine whether the motor vehicle is accelerating or decelerating. If it is determined that the motor vehicle is accelerating or decelerating, the software application can cease to accept user input from the personal computing device's user interface, the external user interface, or both the personal computing device's user interface and the external user interface until such acceleration or deceleration has ceased.

For both the portable musical instrument and the vehicle-mounted musical instrument, the output audio can be made audible using either: 1.) the personal computing device's existing speakers or 2.) any earphones, speaker, or amplification system connected to the personal computing device. For the vehicle-mounted musical instrument the output audio may also be made audible by transmitting the output audio to the vehicle's existing sound system to be played over the vehicle's existing speakers. In such an embodiment, transmission of the output audio from the personal computing device to the vehicle's sound system may occur, without limitation, by means of an audio cable or wirelessly by means of a Bluetooth connection or FM transmission. For wireless transmission, the personal computing device may itself send the output audio to the vehicle sound system, or, an external transmitter connected to the personal computing device may be used to relay the output audio to the vehicle sound system.

In addition to the previously discussed benefits of providing portable access to new sounds, the overall portable nature of the overall portable musical instrument itself is also beneficial. Given that touch-sensitive sensors can be made to be quite small, the overall portable musical instrument system (including the personal computing device) has the potential to be much more simple to transport than other electronic instruments. Furthermore, due to the embodiment's use of a personal computing device, the portable musical instrument also has the potential to be much less expensive to manufacture than other electronic instruments. Consider again electronic musical instruments such as electronic keyboards and electronic drum sets. Manufacturers of these electronic instruments must include electronic components such as a memory module for storing sounds and a processor for ensuring that correct sounds are played at the correct instances. Since both the memory module and processor are expensive electrical components, it is advantageous for a manufacturer of electronic musical instruments to reduce the cost of these components or even completely eliminate these components from the system design.

Rather than manufacturing an electronic musical instrument with an expensive processor and an expensive memory module, the portable musical instrument takes advantage of the processor and memory within the personal computing device to provide overall functionality of the system. The portable musical instrument can communicate with personal computing device through less expensive communication components than the combined cost of memory and processing components. Thus, for manufacturers, the portable musical instrument can allow for significant cost savings over alternative electronic musical instruments.

### BRIEF DESCRIPTION OF THE DRAWING

FIGS. 1, 2, 3, 4 and 5 are functional block diagrams for five embodiments of a system in accordance with the present invention delineating major functional components.

FIG. 6 shows an embodiment in which the touch-sensitive sensors are mounted on a steering wheel cover and a personal computing device is nearby to receive input initiated by the sensors.

FIG. 7 depicts the same embodiment as FIG. 6, but shows further detail on how the steering wheel cover mounts on the steering wheel.

FIG. 8 shows an embodiment of the invention which can be mounted on a steering wheel, but with the personal computing device attaching directly to one of the mounting structures to receive signals from the sensors through a direct electrical connection.

FIG. 9 shows an embodiment of the invention which can be mounted on a steering wheel, but with an alternative number of touch-sensitive sensors and an LED display contained within the one of the mounting structures.

FIG. 10 shows an embodiment of the invention in which individual sensors are each contained in their own mounting structures.

FIG. 11 shows these mounting structures attached to surfaces in a vehicle.

FIG. 12 shows how the sensors might be arranged if the surface was the face of an electric guitar.

### DETAILED DESCRIPTION OF THE INVENTION

In the following detailed description of embodiments of the invention, reference is made to the accompanying drawings (where like numbers represent like elements), which form a part hereof, and in which is shown by way of illustration specific embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the system of the present invention.

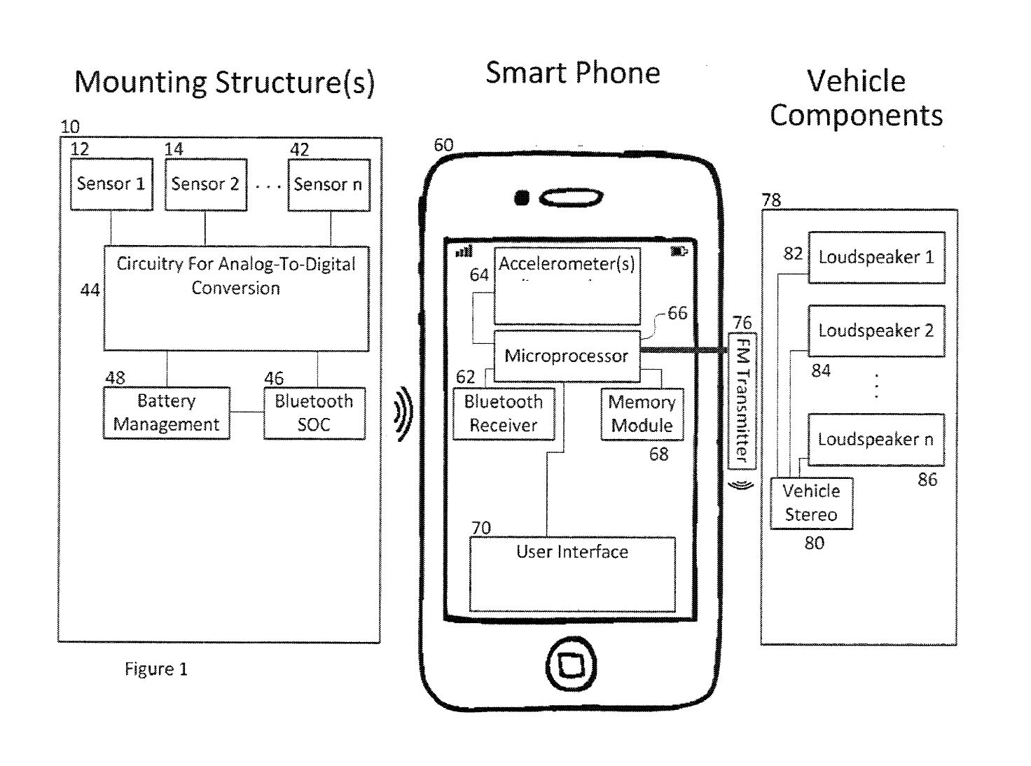

FIG. 1 shows an embodiment of the invention in which input from the touch-sensitive sensors 12, 14, . . . 42 is transmitted to the user's personal computing device 60 (e.g. smartphone). All touch-sensitive sensors 12, 14, . . . 42 are contained within the one or more mounting structures 10. Without limitation, touch-sensitive sensors 12, 14, . . . 42 can be simple on/off switches or they can be analog in nature. Without limitation, on/off switches can include momentary switches and fabric sensors. Fabric sensors are advantageous because they are inexpensive and can be cut to any size and shape with ease. These sensors are typically made with two pieces of conductive fabric separated a small distance from each other by a thin foam-like material with one or more holes. When a user exerts sufficient pressure on a fabric sensor, the foam-like material squishes allowing the two pieces of conductive fabric to touch and momentarily complete a circuit.

Piezoelectric sensors are one example of analog sensors. Analog sensors such as piezoelectric sensors produce an output voltage which increases in a manner commensurate with the force at which they are struck, i.e. increasing the force increases the output voltage. By design, striking an analog sensor with greater intensity creates a louder volume level of the resulting sound. An analog sensor can convey this force information to a personal computing device and software resident on the personal computing device appropriately modifies the volume level of the resulting sounds.

For touch-sensitive sensors 12, 14, . . . 42 that are analog in nature, each sensor is connected to a circuit containing an analog-to-digital converter 44. The circuit containing an analog-to-digital converter 44 would include components to filter, scale, and rectify the signal from the analog sensors. In order to simplify the diagram, functional blocks representing the filtering, scaling, and rectifying steps have been omitted from FIG. 1, however one skilled in the art will recognize that these steps are common when working with analog sensors.

Still referring to the invention of FIG. 1, the one or more mounting structures 10 contain additional functional blocks. An embodiment of the present invention includes a communication interface which, without limitation, makes use of Near Field Communication (NFC), Zigbee, Ultra-Wide Band (UWB), 802.11, infrared, and/or ultrasonic communication techniques and/or the personal computing device's audio jack. In FIG. 1, the communication interface may be a Bluetooth transceiver, specifically, a Bluetooth system-on-a-chip. Included in the one or more mounting structures 10 is at least one Bluetooth system-on-a-chip 46 as well as battery management circuitry 48. The battery management circuitry 48 provides power for the Bluetooth system-on-a-chip 46 and also, if present, the circuit containing an analog-to-digital converter 44. Note that if the touch-sensitive sensors 12, 14, . . . 42 are not analog in nature, the circuit containing an analog-to-digital converter 44 is not necessary and signals produced by the touch-sensitive sensors 12, 14, . . . 42 are sent directly to the Bluetooth system-on-a-chip 46. By way of example and not limitation, the Nordic nRF51822 Bluetooth low-energy (LE) chip can be used as the Bluetooth system-on-a-chip 46. The Bluetooth system-on-a-chip 46 can be programmed to send a specific wireless message to the personal computing device whenever one of the touch-sensitive sensors 12, 14, . . . 42 is triggered. The wireless message contains the identity of the triggered sensor and, if the triggered sensor is analog in nature, the message contains voltage information to convey the force at which the sensor was struck.

In an embodiment, the message transmitted from the communication interface includes an integer value (e.g. 0-15 if there are 16 touch sensors). This integer value is used by the personal computing device (e.g. the smartphone) to identify the triggered touch sensor, and is also used to control the music software application on the personal computing device according to a function associated with the triggered touch sensor (i.e. the smartphone receives the integer and executes a function in the application that is associated with the integer). This association between the integer and the function of the application is preprogrammed into the software application by the application developer or a third party.

For example, if the user touches sensor 1 on the device, the smartphone may receive an integer value of 1. An application (e.g. a music/sound application) running on the smartphone identifies that sensor 1 has been triggered based on this integer value. The music application then directs the smartphone to initiate some function (e.g. play a first sound) associated with the integer value 1. If the user then touches sensor 2 on the device, the smartphone receives an integer value of 2. The smartphone then initiates a function (e.g. play a second sound) associated with the integer value 2. The association of the integer values and the functions of the application are pre-programmed into the smartphone so that the smartphone knows how to control the application based on the integer numbers received from the smartphone. The sound being played by the smartphone can be musical, non-musical, sound effects, or any other type of sound stored in the smartphone.

Bluetooth LE specification may be used for communication with the personal computing device. A short range wireless specification like Bluetooth or a wired connection may be all that is needed for the disclosed system to communicate with the personal computing device. The user's personal computing device is with the musician and thus communication distances are very far. Furthermore, Bluetooth LE in particular consumes little power and thus the specification promotes longer battery life for the overall system. Also contributing to longer battery life, the system may be capable of a low power state when the system is not in use, i.e. the system has not received user-triggered sensor inputs for an extended period of time. This low power state functionality is an additional functionality which can be programmed into the Bluetooth system-on-a-chip 46.

Batteries which power the part of the system contained within the one or mounting structures 10 are included in the battery management circuitry 48. In some embodiments, the system is powered by two AAA batteries, however, without limitation coin cell batteries and rechargeable lithium-ion batteries are also possible sources of power.

In further detail, still referring to the invention of FIG. 1, the personal computing device 60 is represented as a smart phone. Without limitation, smart phones include iPhone™ and Android™ phones. Standard and relevant smart phone components include a Bluetooth receiver 62, a processor 66, a memory module 68, and a user interface 70. Many smart phones also include one or more accelerometers 64.

Referring to the invention of FIG. 1 in still further detail, the Bluetooth receiver 62 receives signals sent by the Bluetooth system-on-a-chip 46. Software applications stored in the memory module 68 make use of these signals as input when the software applications are run using the processor 66. The one or more accelerometers 64 are not necessary for system functionality, but if present they can also provide input to software applications running on the processor 66.

Without limitation, accelerometer input can be used in embodiments in which the user is situated within a motor vehicle to help detect when the vehicle is in motion. Typical elements of the user interface 70 such as, without limitation, touchscreens, track balls, and keyboards can be disabled in the software application when the vehicle is in motion in order to promote safer driving.

Still referring to embodiments in which the user is situated within a motor vehicle, audio output can be optionally rerouted to the user's vehicle 78. When rerouting audio output, relevant components of a user's vehicle include the vehicle stereo 80 and the vehicle loudspeakers 82, 84, and 86. Note that a vehicle may have any number of loudspeakers.

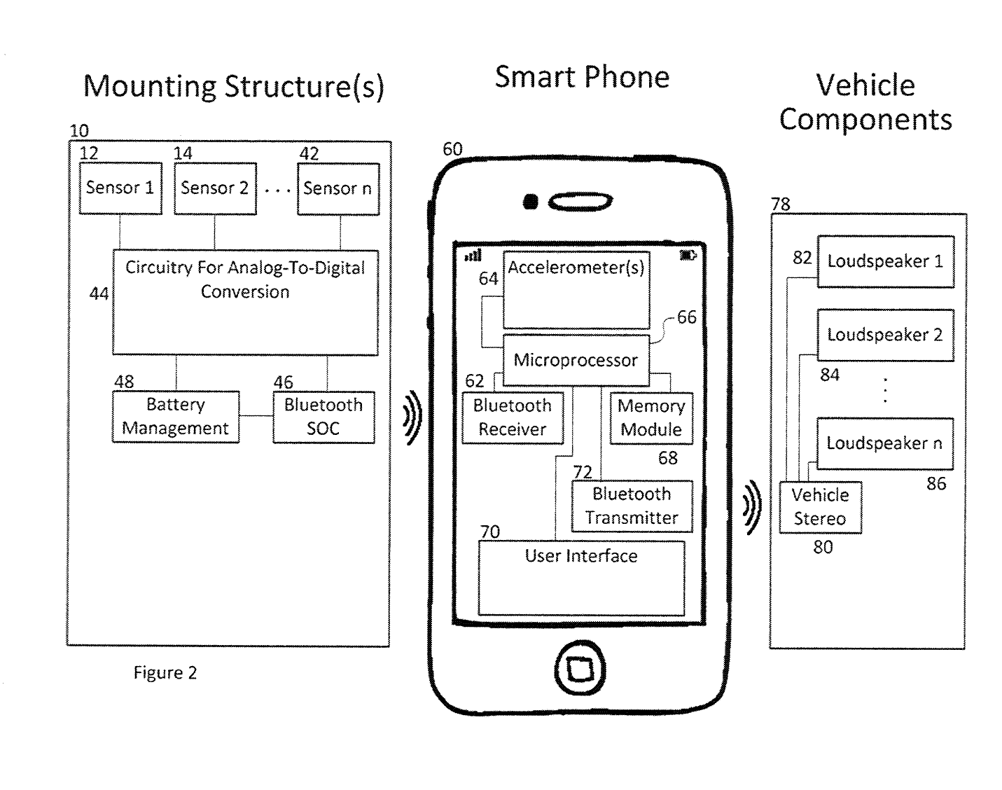

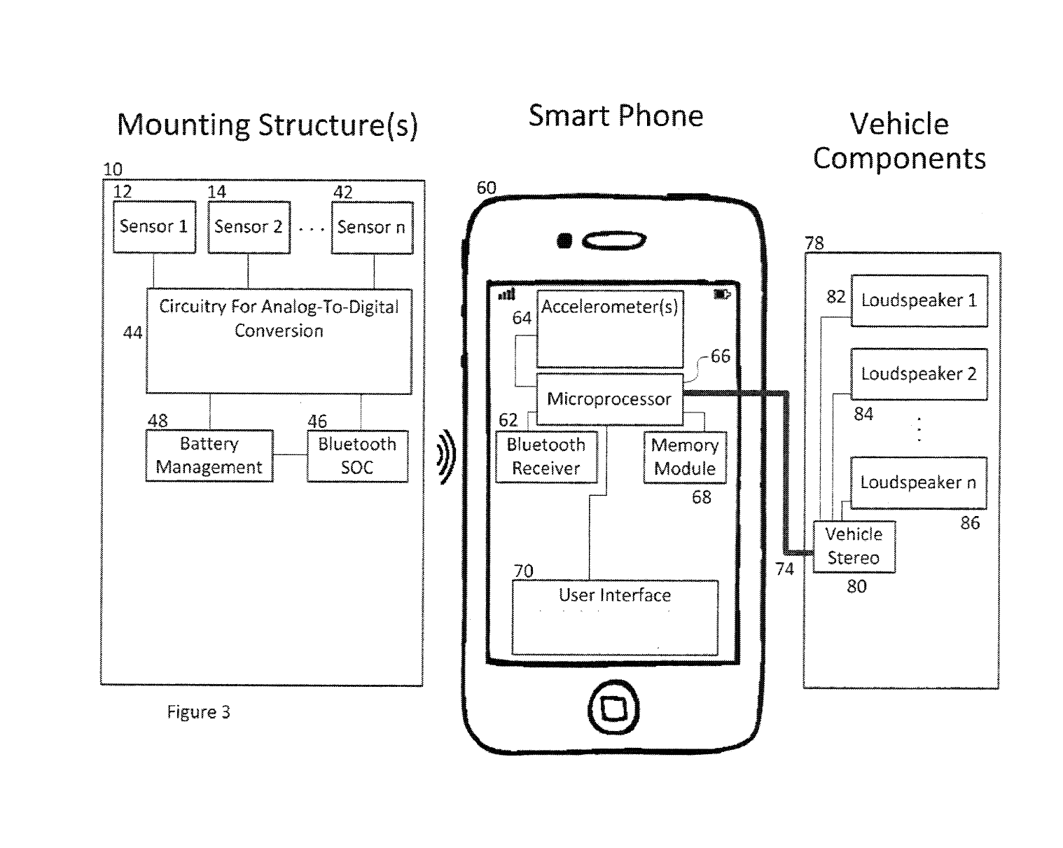

FIG. 1 depicts an embodiment in which the processor 66, running a software application which produces audio output, sends the audio output to the vehicle stereo 80 using an FM transmitter 76. For newer vehicles with Bluetooth capability, an alternative embodiment is depicted in FIG. 2 in which the audio output is instead sent by the processor 66 running the software application to the vehicle stereo 80 by way of a Bluetooth transmitter 72. FIG. 3 depicts yet a third embodiment in which the processor 66 running the software application sends the audio output to the vehicle stereo 80 over a direct electrical connection 74. Without limitation, this third embodiment is most easily realized on a vehicle 78 with a “line-in” adapter for accepting ⅛″ miniplugs from audio sources. Most personal computing devices have ⅛″ “line-out” adapters which are often used for headphones, ear buds, or computer speakers. In its simplest form, the direct electrical connection 74 is an audio cable with an ⅛″ miniplug on either side where one of ⅛″ miniplugs is inserted into the “line-out” adapter of the personal computing device 60 and the other ⅛″ miniplug is inserted into the “line-in” adapter of the vehicle 78.

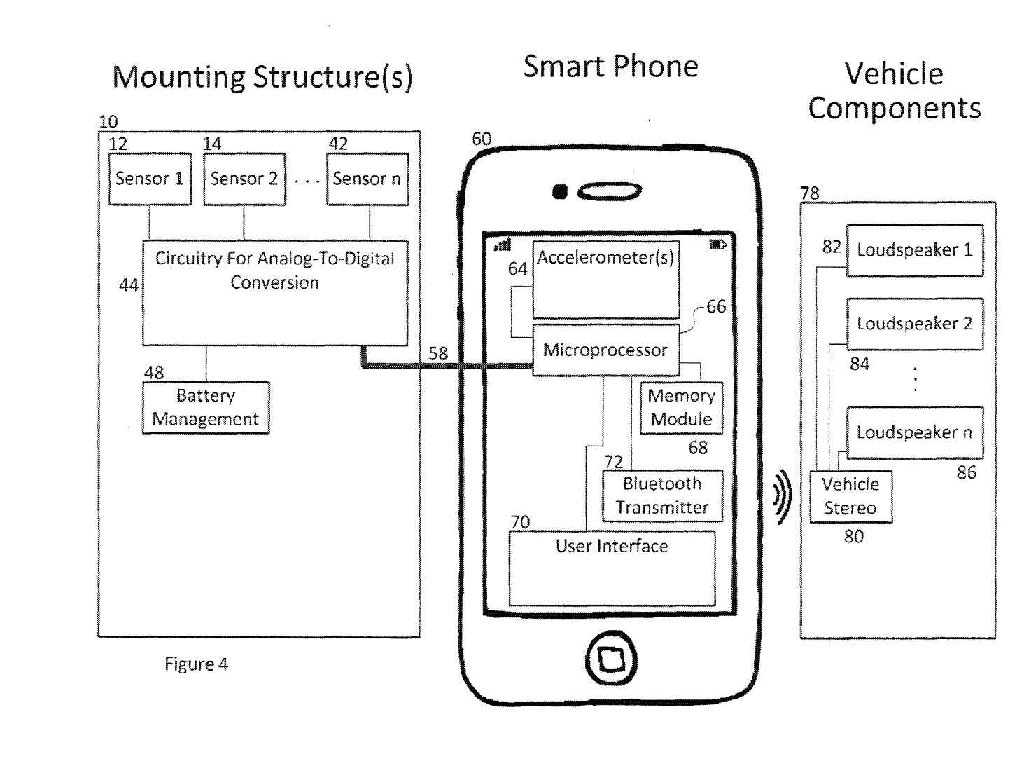

FIG. 4 depicts a fourth embodiment in accordance with the present invention. Although it is often desirable for the signals produced from the touch-sensitive sensors 12, 14, . . . 42 to be transmitted wirelessly to the personal computing device 60, these signals may also be transmitted to the personal computing device 60 by means of a direct electrical connection 58. Without limitation, if the personal computing device 60 was an iPhone™, this direct electrical connection 58 might be attached to the iPhone™ lightning port. In the FIG. 4 embodiment, input from the touch-sensitive sensors 12, 14, . . . 42 is sent directly to the software application running on processor 66. Once again, the circuit containing an analog-to-digital converter 44 performs appropriate filtering, scaling, rectifying, and analog-to-digital conversion if the sensors are analog sensors. For analog sensors, the circuit containing an analog-to-digital converter 44 sends the signals over the direct electrical connection 58. For sensors which are not analog, the circuit containing an analog-to-digital converter 44 is not necessary and the touch-sensitive sensors 12, 14, . . . 42 may send signals directly over the direct electrical connection 58.

Thus far, uni-directional communication with the personal computing device 60 has been discussed, i.e. sending sensor-initiated signals from the one or more mounting structures 10 to the personal computing device 60. However, with the direct electrical connection 58, bi-directional communication with the personal computing device 60 is now possible, i.e. signals emanating from the personal computing device 60 can also be sent to the one or more mounting structures 10.

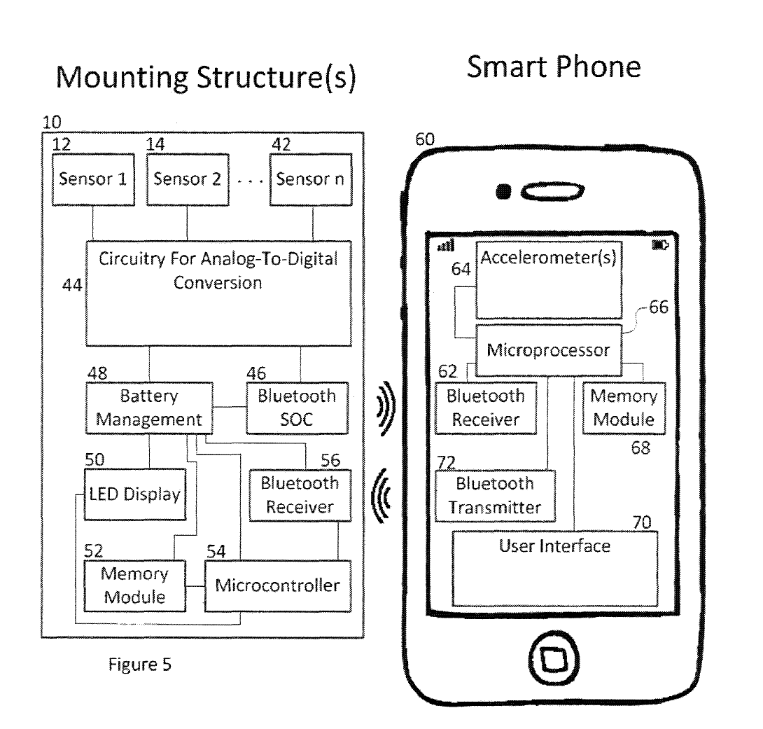

FIG. 5 shows an embodiment which utilizes bi-directional communication. In this embodiment, signals emanating from the personal computing device 60 are not sent over a direct electrical connection. Instead, the signals are sent wirelessly. A software application running on processor 66 may produce graphics data to be displayed. This graphics data can be wirelessly transmitted by way of a Bluetooth transmitter 72. It should be noted that, at this time, the Bluetooth LE protocol supports low data rates. Hence, Bluetooth LE might not be the optimum protocol for transmitting high-fidelity graphics data. For high-fidelity graphics, Bluetooth Classic protocol could be the protocol used in this embodiment due to the protocol's higher data rates.

The embodiment depicted in FIG. 5 contains additional components within the one or more mounting structures 10 for receiving and displaying graphics data. Most notably these components include a LED display 50, a memory module 52, a microcontroller 54, and a Bluetooth receiver 56. The battery management circuitry 48 provides power to these additional components.

Still referring to the embodiment of FIG. 5, the Bluetooth receiver 56 can receive graphics data from the Bluetooth transmitter 72. Using instructions stored on the memory module 52, the microcontroller 54 ensures that the graphics data received by the Bluetooth transmitter 72 is properly displayed on the LED display 50.

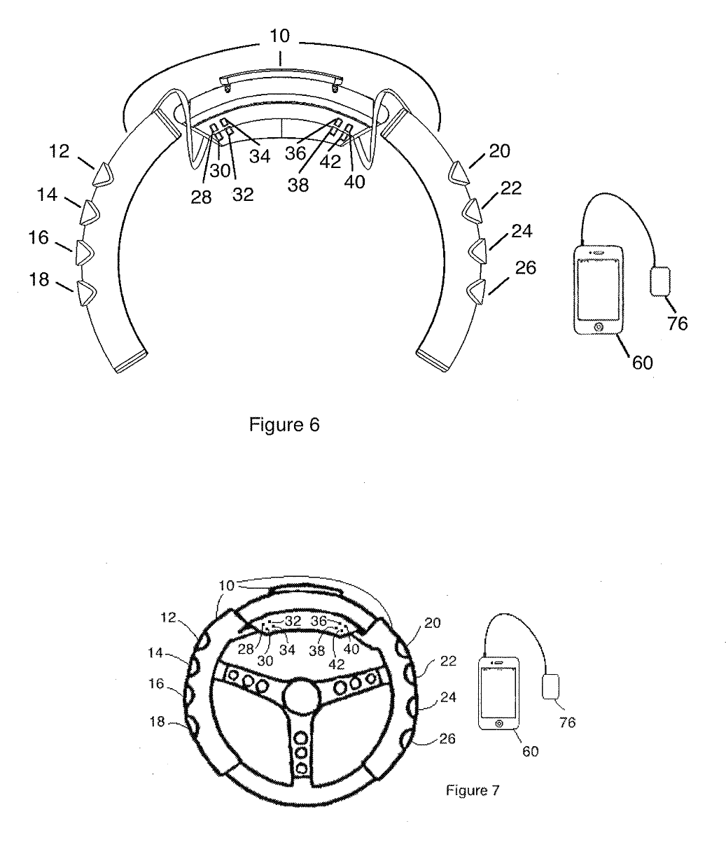

FIG. 6 and FIG. 7 both depict the same physical embodiment of the invention which was described by the functional block diagram of FIG. 1. FIG. 6 depicts the invention before it is mounted on a steering wheel and FIG. 7 depicts the invention after it is mounted. In this physical embodiment, three (3) mounting structures make up the one or more mounting structures 10 with the center mounting structure connected by wires to each of the two outer mounting structures. One set of wires carries the electrical signals to the center mounting structure from the touch-sensitive sensors 12, 14, 16, and 18 contained in one of the outer mounting structures while the other set of wires carries the electrical signals from the touch-sensitive sensors 20, 22, 24, and 26 contained in the second of the outer mounting structures. Wireless signals produced by the apparatus are received by the personal computing device 60, which, in turn, may produce audio output which is wirelessly transmitted using the FM transmitter 76.

Still referring to the embodiment of FIG. 6 and FIG. 7, the center mounting structure is made out of hard plastic or another sufficiently rigid material and is removably attached to the steering wheel by means of a clamp which can be tightened around the steering wheel using a screw. This center mounting structure also contains 8 of the 16 touch-sensitive sensors, namely touch-sensitive sensors 28, 30, 42, and the circuit board with the electrical components necessary for communication with the personal computing device 60.

In further detail, still referring to the embodiment of FIG. 6 and FIG. 7, the outer two mounting structures are made of soft plastic, rubber, or a similar flexible material and each is removably attached to the steering wheel by means of a pressure fit around the steering wheel and two velcro straps (one at each end). Each outer mounting structure is molded to fit, almost precisely, the size and shape of a steering wheel and the velcro straps can pull tighter to force the flexible material of the mounting structure to flex inward and create more friction between the mounting structure and the wheel. Each of the outer two mounting structures also contains 4 of the 16 touch-sensitive sensors, with one of these mounting structures containing touch-sensitive sensors 12, 14, 16, and 18 and the other containing touch-sensitive sensors 20, 22, 24, and 26. All of the touch-sensitive sensors 12, 14, . . . 26 are fabric sensors. Finally, each outer mounting structure is covered by a fabric overwrap except the portion of each outer mounting structure in contact with the steering wheel and except the areas of each outer mounting structure directly above each of the fabric sensors. This area above the fabric sensors is covered with velcro. Velcro sewn onto or otherwise adhered to fabric patches attach to the velcro covering the area above the fabric sensors.

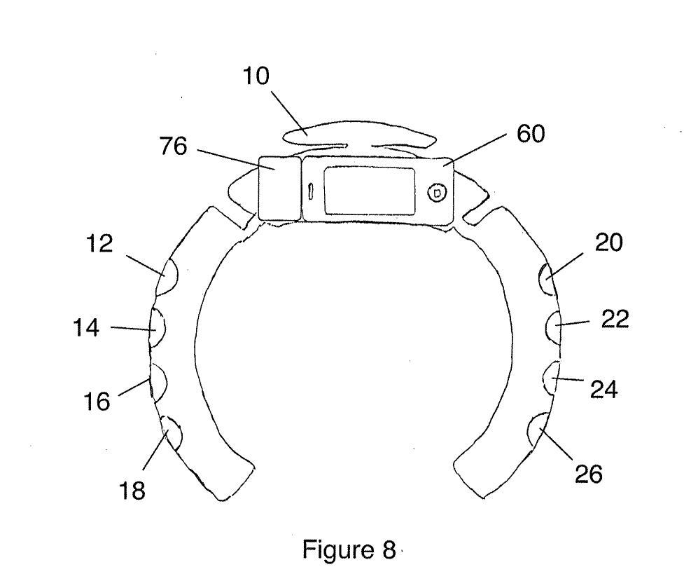

FIG. 8 depicts a physical embodiment of the functional block diagram shown in FIG. 4. FIG. 8 shows a wired connection between a smart phone (representing the personal computing device 60) and a steering wheel cover (representing one or more mounting structures 10) in which the smart phone snaps into the wheel cover to make the direct electrical connection 58 depicted in FIG. 4. In this embodiment, the smart phone's user interface 70 is more accessible and can even provide an alternative graphics display to FIG. 5's LED display 50.

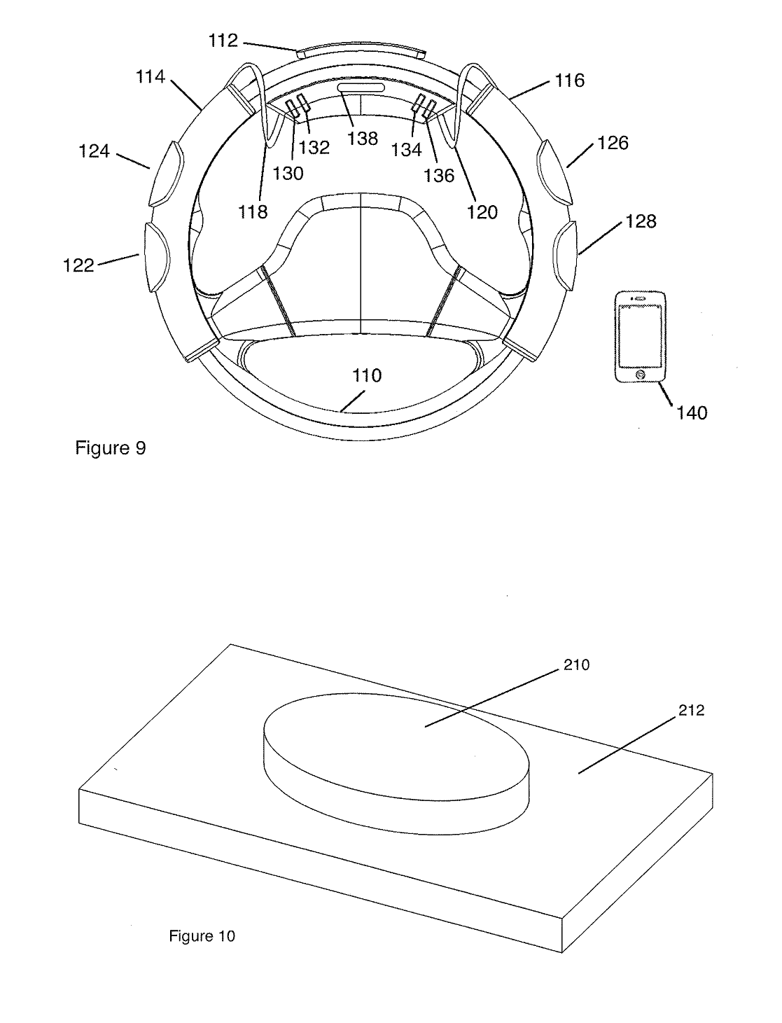

FIG. 9 depicts a physical embodiment which utilizes a bi-directional communication channel with a personal computing device, in this case personal computing device 140. This bi-directional communication channel is akin to the bi-directional communication channel depicted in the functional block diagram shown in FIG. 5. FIG. 5 discusses a LED display 50 contained with one or more mounting structures 10 and in FIG. 9 the LED display 138 is contained within center mounting structure 112.

Still referring to the invention of FIG. 9, the touch-sensitive sensors 122, 124, . . . 136 are contained within the three (3) mounting structures: center mounting structure 112, leftmost mounting structure 114, and rightmost mounting structure 116. Center mounting structure 112 is removably attached to the motor vehicle's steering wheel 110 by means of a clamp and contains the electronics interface as well as touch-sensitive sensors 130, 132, 134, and 136. Leftmost mounting structure 114 is removably attached to the motor vehicle's steering wheel 110 by means of a pressure fit, i.e., the mounting structure is molded to fit, almost precisely, the size and shape of a steering wheel and is made out of flexible material which flexes inward to make a stronger grip on a steering wheel and thus, the mounting structure fits snugly on the steering wheel and is unable to significantly deviate its position on the steering wheel. Touch-sensitive sensors 122 and 124 are contained within leftmost mounting structure 114 and wire bundle 118 carries signals from these sensors to the electronics interface within center mounting structure 112. Similarly, rightmost mounting structure 116 is also removably attached to the motor vehicle's steering wheel 110 by means of a pressure fit and contains touch-sensitive sensors 126 and 128. Wire bundle 120 carries signals from these sensors to the electronics interface.

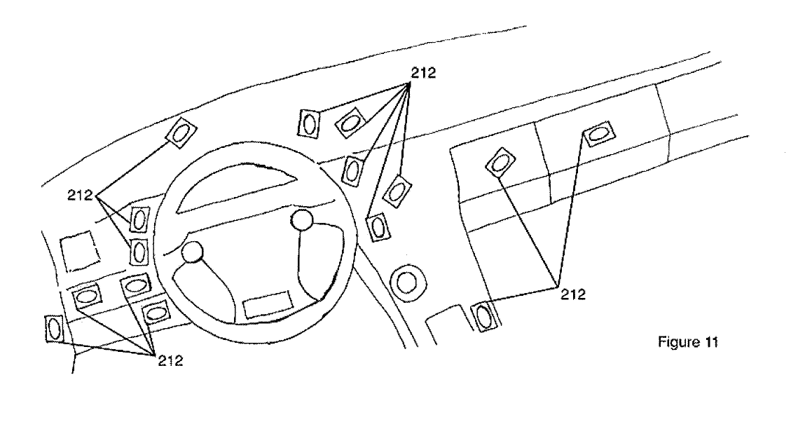

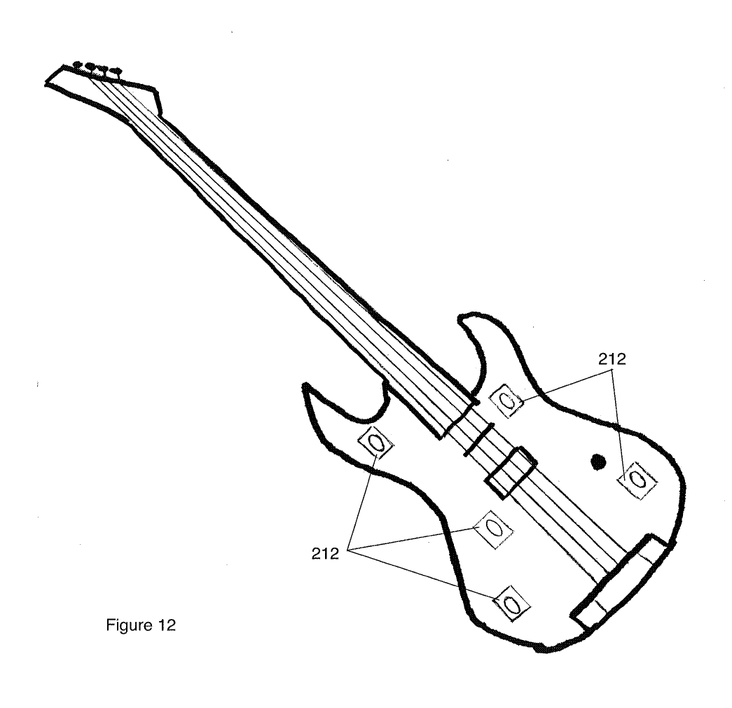

FIG. 10 depicts a physical embodiment in which a mountable device includes an individual touch-sensitive sensor 210 contained in its own mounting structure 212. One or more instances of the mounting structure 212 can be placed on any surface, including desired locations within a motor vehicle as shown in FIG. 11 or on a the body of an electric bass guitar as shown in FIG. 12 (in order to provide a guitarist with the means to add musical accompaniment from the embodiment during his guitar performance). Without limitation, velcro can be used to removably attach a mounting structure 212 to the surface. In this embodiment, velcro is located on the side of mounting structure 212 which is opposite the side on which touch-sensitive sensor 210 is located. Mated for attachment with the velcro on mounting structure 212, an adhesive piece of velcro is adhered to the surface at the desired location.

Still referring to the embodiment of FIG. 10, FIG. 11, and FIG. 12, it is important to note that although one or more individual touch-sensitive sensors could be used on their own to provide input to the software application running on the personal computing device, these sensors could also be used in conjunction with the embodiment depicted in FIG. 6, FIG. 7, FIG. 8, or FIG. 9 to provide such input to the software application.

It should be noted that the musical instrument can be a conventional musical instrument or a plastic replica of a musical instrument. The guitar in FIG. 12 can be a conventional guitar with the mountable touch sensors attached by the manufacturer or the user. Alternatively, the guitar in FIG. 12 may be a plastic replica of a guitar that can be made cheaply. In this example, the mountable touch sensors can be attached to the replica of the guitar by the manufacturer or the user.

It should also be noted that the mountable device in FIG. 10 can be mounted to any surface including but not limited to the interior surface of a vehicle, a toy, clothing, a musical instrument, a replica of a musical instrument, and generally any surface that is within reach of the user so that the user can trigger the sensor to instruct the personal computing device to play the sound.

Provided herein is a system for generating an output audio signal using a personal computing device which includes: the personal computing device's user interface, a memory module for storing one or more musical or non-musical sounds, and a processor which can run a software application. The overall system includes an external user interface which is external to the personal computing device, adapted to receive user input, and has an electrical output and an electronic interface, electrically coupled to the external user interface, removably connectable to the personal computing device, and configured to relay user input information to a software application running on the processor. The system also includes one or more mounting structures, at least one of which is configured for containing the external user interface and at least one of which is configured for containing the electronic interface. Using instructions contained in the software application, the processor interfaces with the memory module and generates the output audio signal. The output audio signal includes, at such times dictated by the user input received by the external user interface, one or more of the stored musical or non-musical sounds stored in the memory module.

Without limitation, the personal computing device can be a smart phone, electronic tablet, or laptop. The term “smart phone” includes, without limitation, Android™, iPhone™, and Microsoft™ phones, and the term “electronic tablet” includes, without limitation, Android, iPad, and Windows-based tablets.

In an embodiment, the processor can be replaced by, without limitation, a field-programmable gate array, a digital signal processor, a microcontroller, or a programmable intelligent computer, and the memory module can be replaced by, without limitation, flash memory, programmable read-only memory, erasable PROM, electronically erasable PROM, and electronically alterable read-only memory.

Without limitation, the stored musical or non-musical sounds can include the sounds of a bass drum, snare, tom drum, high-hat, ride cymbal, crash cymbal, splash cymbal, or cowbell or even the sound of a guitar, bass, keyboard, or other musical instrument. The stored musical or non-musical sounds may also include, without limitation, the sounds of animals and human speech.

In an embodiment, a portion of the external user interface is contained within more than one of the mounting structures. The external user interface may include, without limitation, rotary dials, a microphone, a digital camera, a touchscreen, one or more infrared sensors, and/or one or more photovoltaic sensors for receiving user input.

In an embodiment, the software application may also have relayed to it, user input information received by the personal computing device's user interface. Without limitation, such user input can include visual input received using the camera contained in the personal computing device, audio input received using the microphone contained in the personal computing device, or tactile input received using one or more tactile reception points. Without loss of generality, tactile reception points may refer to: a track ball, a touch-sensitive sensor contained within the personal computing device's user interface, and/or a virtual button on the touchscreen of the personal computing device. It is also noted that virtual buttons are associated with instructions (e.g. certain functions) within the software application.

In one such embodiment, the personal computing device may also include one or more accelerometers in communication with the processor. Using instructions contained in the software application, a tactile reception point receiving tactile input can be used in conjunction with input from one or more of the accelerometers to approximate the relative force of tactile input imparted on the tactile reception point.

In another such embodiment, the external user interface may include, without limitation, one or more touch-sensitive sensors. Upon receiving tactile input, the touch-sensitive sensors are designed to allow a signal to be passed to the electrical interface. In turn, the electronic interface relays user input information to the software application running on the processor regarding, without limitation, which of the touch-sensitive sensors has just received the tactile input.

Without limitation, one or more of the one or more touch-sensitive sensors contained in the external user interface can be momentary switches which allow a discrete signal to be passed to the electrical interface upon receipt of the tactile input. Without limitation, some of these momentary switches can be fabric sensors, i.e. sensors made with two pieces of conductive fabric separated a small distance from each other by a thin foam-like material. The foam-like material has one or more holes such that a circuit is momentarily completed when a user exerts sufficient pressure on the fabric sensor to squish the foam-like material enough for the two pieces of conductive fabric to come in contact with each other.

Without limitation, one or more of the one or more touch-sensitive sensors can be analog sensors capable of approximating the relative force of tactile input imparted upon them. In one such embodiment, the analog sensors are piezoelectric sensors. Whenever any of these analog sensors receives tactile input, an analog signal containing information about the relative force of the tactile input is sent to the electronic interface. In such an embodiment, the electronic interface includes a circuit containing a.) electrical components necessary to filter, scale, and rectify the analog signal passed to the electrical interface into a filtered, scaled, and rectified version of the analog signal and b.) an analog-to-digital converter for converting the filtered, scaled, and rectified version of the analog signal to a discrete version of the signal. The filtered, scaled, rectified, and discretized version of the signal, which includes information regarding the relative force of tactile input, is then included in the user input information relayed to the software application. Without limitation, the area above each of the touch-sensitive sensors can be covered with velcro and said velcro is meant to attach to velcro sewn onto, or otherwise adhered to, fabric patches.

Without limitation, using the instructions contained in the software application, a particular musical or non-musical sound from the memory module can be assigned to one or more of the one or more touch-sensitive sensors or to one or more of the one or more tactile reception points. When a touch-sensitive sensor or tactile reception point with an assigned sound receives tactile input, the processor ensures that the sound assigned to that touch-sensitive sensor or tactile reception point is included in the output audio signal at such times that the touch-sensitive sensor or tactile reception point receives the tactile input.

Without limitation, the software application may concurrently allow the same musical or non-musical sound to be assigned to any touch-sensitive sensor or tactile reception point. Furthermore, without limitation, the software application may concurrently allow the same sequence of sounds to be assigned to any touch-sensitive sensor or tactile reception point where a sequence of sounds refers to, without loss of generality, a sequence of musical sounds, a sequence of non-musical sounds, or a sequence of both musical and non-musical sounds.

In an embodiment, a sequence of sounds from the memory module may be assigned to one or more of the one or more touch-sensitive sensors or to one or more of the one or more tactile reception points. When a touch-sensitive sensor or tactile reception point with an assigned sequence of sounds receives tactile input, the processor ensures that the sequence of sounds assigned to that touch-sensitive sensor or tactile reception point is included in the output audio signal at such times that the touch-sensitive sensor or tactile reception point receives the tactile input.

In one such embodiment, the software application may concurrently allow any touch-sensitive sensor or tactile reception point to have the same sequence of musical or non-musical sounds assigned to it. Furthermore, the software application may also concurrently allow any touch-sensitive sensor or tactile reception point to have a sequence of sounds associated with it that has the same timing of musical or non-musical sounds within the sequence as a second sequence of sounds associated with another touch-sensitive sensor or tactile reception point.

Upon activation of any touch-sensitive sensor or tactile reception point to which a sound or sequence of sounds is assigned, user input information relayed to the software application includes information regarding the relative force of tactile input imparted on said sensor or tactile reception point. Furthermore, the software application ensures that the resulting sound or sequence of sounds contained in the output audio signal has a volume level commensurate with that force. In other words, striking a sensor or tactile reception point with greater intensity would result in a louder volume level for the sound or sequence of sounds associated with the sensor or tactile reception point which was struck.

In an embodiment, user customization in assigning an individual sound or sequence of sounds to a touch-sensitive sensor or tactile reception point, including the relative start times of sounds in a sequence and any audio effects applied to an individual sound or a sound within a sequence, is achieved through user interaction with the external user interface, the personal computing device's user interface, or a combination of both the external user interface and the personal computing device's user interface. For example, using instructions contained in the software application and a personal computing device with the capability to connect to the internet and download data from the internet, the external user interface and/or personal computing device's user interface can be made to allow for user selection of a musical or non-musical sound from musical and non-musical sounds resident on an internet accessible server. Upon user selection, a selected sound is downloaded from the internet accessible server and stored in the memory module before the sound's subsequent assignment to a touch-sensitive sensor or tactile reception point as an individual sound or as part of a sequence of sounds.

In such an embodiment, an external media or an external memory module might also be removably connected to the electronic interface or the personal computing device. Using instructions contained in the software application the external user interface and/or personal computing device's user interface can be made to allow for user selection of a musical or non-musical sound from musical and non-musical sounds resident on the external media or external memory module. Upon user selection, a selected sound may be assigned to a touch-sensitive sensor or tactile reception point as an individual sound or as part of a sequence of sounds.

In an embodiment, the electronic interface is removably connectable to the personal computing device by means of a wire, cable, or other direct electrical connection, and the wire, cable, or other direct electrical connection is attached to, without limitation, a firewire port, USB port, or iPhone™ lightning port. In an embodiment, one of the one or more mounting structures is configured to removably receive the personal computing device and hold it in place within this mounting structure. The personal computing device can be held in the mounting structure by means of, without limitation, one or more of: a suction cup, a spring clip, a clamp which can be tightened about the personal computing device using one or more screws, an adhesive velcro strip adhered to the personal computing device and mated for attachment with velcro sewn onto, or otherwise adhered to, a portion of the mounting structure, a strap or pair of straps made of, without limitation, elastic, fabric, or plastic, configured to be tightened about the personal computing device to hold it in place, and a pressure fit such that a portion of the mounting structure is molded to precisely accept the size and shape of the personal computing device snugly such that, when the personal computing device is inserted into said portion of the mounting structure, the personal computing device is prevented from moving in one or more directions with respect to the mounting structure.

In an embodiment, the electronic interface: a.) includes one or more wireless transmitters and b.) is removably connectable to the personal computing device by means of one or more wireless connections established between any of its one or more wireless transmitters and a wireless receiver contained within the personal computing device. The one or more wireless transmitters use a wireless specification such as, without limitation, Wi-Fi, Bluetooth 3.0, or Bluetooth LE, and each of the one or more wireless transmitters can be, without limitation, a Bluetooth system-on-a-chip such as, without limitation, a Nordic nRF51822 Bluetooth low-energy (LE) chip, a Texas Instruments CC2540, a CSR 1011, or a Bluegiga BLE112 Bluetooth Smart module. In one such embodiment, the apparatus can enter a low power state when the user interface has not received user input for an extended period of time due to a functionality programmed into each instance of the Bluetooth system-on-a-chip.

In an embodiment, electrical components within the electronic interface are powered by one or more batteries, where the one or more batteries are, without limitation, AAA batteries, a coin cell battery, or a rechargeable lithium-ion battery. The electronic interface may also include, without limitation, a kinetic energy gathering component, wherein the one or more batteries can be trickle charged by the kinetic energy gathering component.

In an embodiment, a portion of the electronic interface is contained in more than one mounting structure. In one such embodiment, portions of the electronic interface are connected together by means of wires, cables, or other direct electrical connection and each portion of the electronic interface is connected to at least one other portion of the electronic interface. Without limitation, these portions of the electronic interface could alternatively be connected together by wireless connection such that each wirelessly connected portion has one or more wireless transmitters and/or one or more wireless receivers in order to establish the wireless connection.

In an embodiment, at least one adhesive piece of velcro is adhered to a surface and at least one of the mounting structures has velcro mated for attachment to the velcro adhering to the surface. In another embodiment, one or more of the mounting structures can attach to a surface by means of, without limitation, adhesive and/or one or more suction cups.

In yet another embodiment, one or more of the mounting structures are each removably connected to the steering wheel of a motor vehicle by means of, without limitation, one or more of: a spring clip configured to grab the steering wheel, a clamp which can be tightened around the steering wheel using one or more screws, a strap or pair of straps made of, without limitation, elastic, fabric, or plastic, configured to be wrapped around the steering wheel and tightened, and a pressure fit such that the mounting structure is a.) molded to fit, almost precisely, the size and shape of the steering wheel so that it snugly fits on the steering wheel and b.) made out of flexible material which flexes inward to make a stronger grip on the steering wheel such that the mounting structure is unable to significantly deviate its position on the steering wheel. In one such embodiment, any pair of straps can be tightened by means of, without limitation, a knot, velcro sewn onto or otherwise attached to both straps, or any form of belt buckle.

In another such embodiment, any of the singular straps can be tightened by means of, without limitation: a hole or loop on the side of mounting structure directly opposite the side from which the strap emanates such that the strap passes through the loop and a knot can be tied, any form of belt buckle on the side of mounting structure directly opposite the side from which the strap emanates, a hole or loop in the strap which fits over a peg on the side of mounting structure directly opposite the side from which the strap emanates, or mating velcro on two different areas of the strap such that when the strap passes through a loop on the opposite side of the mounting structure from which it emanates the two areas of mating velcro face each other and can attach to each other.

In yet another such embodiment, the areas of one or more of the one or more mounting structures which come in contact with the steering wheel are made from, without limitation, rubber or soft plastic with a coefficient of friction high enough to maximize the effect of the pressure fit and minimize the possibility of unwanted slippage on the steering wheel.

In yet still another such embodiment, the external user interface includes one or more touch-sensitive sensors and a subset of said touch-sensitive sensors are arranged in a substantially circular array on the one or more mounting structures removably connected to the steering wheel.

In yet still another such embodiment, the one or more mounting structures removably connected to the steering wheel also include, as part of the electronic interface, a vibration system to produce tactile vibrations which can be felt by a driver holding or otherwise touching the steering wheel. This haptic feedback system (not shown) could be mounted inside mounting structure 10 in a position in proximity to the user's (e.g. driver's) hands when they are placed on the steering wheel. This haptic feedback system may also be connected to analog to digital circuitry 44 of FIG. 5, and could be triggered by a signal transmitted from the personal computing device to the mounting structure 10. For example, a music application running on the personal computing device may send a signal to the transceiver of mounting structure 10. The transceiver may then trigger the haptic feedback system to vibrate via the analog to digital conversion circuitry. This vibration lets the driver know that action may be needed (e.g. certain sensor should be triggered at a certain point in a song).

In some cases, one or more portable external speakers with a wireless receiver may be available. In some cases, the personal computing device may include, in communication with the processor and without limitation, one or more speakers built into the personal computing device and an output audio receptacle into which is plugged: one or more speakers, a pair of headphones, a pair of earbuds, or an audio cable connected to a motor vehicle's “line-in” adapter for accepting ⅛″ miniplugs from audio sources. In some cases, the personal computing device may also include, without limitation, a wireless transmitter and/or a wireless receiver and a wireless transmitter. Furthermore, in some cases a motor vehicle may include a “line-in” adapter for accepting ⅛″ miniplugs from audio sources or a wireless receiver for receiving audio data such that the motor vehicle stereo makes the audio data it receives audible to the occupant of the motor vehicle over the speakers in the motor vehicle.

In such cases, one of three things may happen. Using instructions contained in the software application, the output audio signal can, without limitation, be made audible using the one or more portable external speakers such that the personal computing device is removably connectable to the portable external speakers by means of a wireless connection established between the wireless transmitter contained within the personal computing device and the wireless receiver contained within the portable external speakers and the audio data is sent wirelessly to these speakers.

Using instructions contained in the software application, the output audio signal can also, without limitation, be made audible using: the one or more speakers built into the personal computing device, the one or more speakers plugged into the output audio receptacle of the personal computing device, the pair of headphones plugged into the output audio receptacle of the personal computing device, the pair of earbuds plugged into the output audio receptacle of the personal computing device, or speakers built into the electronic interface.

In the case of the speakers built into the electronic interface: a.) the electronic interface is removably connectable to the personal computing device by means of a bi-directional communication channel, b.) the output audio signal is sent to the electronic interface over this bi-directional communication channel, and c.) the electronic interface includes an output audio interface for making the output audio signal audible to the occupant of the motor vehicle. In this case, one of two things can happen. The bi-directional communication channel could be established by means of a wire, cable, or other direct electrical connection and the software application ensures proper output of the output audio signal on the output audio interface or the electronic interface could include, without limitation, a wireless transmitter, a wireless receiver, the electronic interface's memory module, and the electronic interface's microcontroller. In this second case, the bi-directional communication channel between the personal computing device and the electronic interface is established wirelessly between a.) the wireless transmitter of the electronic interface and the wireless receiver of the personal computing device and b.) the wireless transmitter of the personal computing device and the wireless receiver of the electronic interface, and using programming code stored in the electronic interface's memory module as guidance, the electronic interface's microcontroller ensures proper output of the output audio signal on the output audio interface.

Using instructions contained in the software application, the output audio signal can also, without limitation, be made audible using the audio speakers of a motor vehicle. In this case, one of two things may happen, The output audio signal can be redirected to the motor's vehicle's stereo using the audio cable connected to the motor vehicle's “line-in” adapter for accepting ⅛″ miniplugs from audio sources and the motor vehicle stereo can make the output audio signal audible to the occupant of the motor vehicle over the speakers in the motor vehicle. The other option is that the personal computing device can be removably connectable to the motor vehicle's stereo system by means of a wireless connection established between the wireless transmitter contained within the personal computing device and the wireless receiver contained within the motor vehicle and the output audio signal can be wirelessly redirected to the motor vehicle's stereo system using this wireless connection at which point the motor vehicle stereo makes the output audio signal audible to the occupant of the motor vehicle over the speakers in the motor vehicle. In such a case, the wireless transmitter and wireless receiver could use a wireless specification such as, without limitation, Bluetooth 3.0, Bluetooth LE, or FM transmission.

In an embodiment, the personal computing device has the capability to connect to the internet and download data from the internet. In this embodiment, using instructions contained in the software application, the output audio signal not only includes any sounds or sequences of sounds assigned to touch-sensitive sensors or tactile reception points at such times when those touch-sensitive sensors or tactile reception points receive tactile input, but also includes, continuously playing and digitally mixed with the sounds or sequences of sounds, a backing track of recorded music. This backing track is selected by the user using the external user interface or the personal computing device's user interface and, without limitation is selected from: real-time streaming internet radio and one or more audio files including, without limitation, recorded music stored in: the memory module of the personal computing device, external media or an external memory module removably connected to the electronic interface or the personal computing device, or an internet accessible server. For a selected backing track from the internet (i.e., without limitation, real-time streaming internet radio and audio files stored in an internet accessible server), said backing track from the internet is downloaded, in full or in part, to the personal computing device's memory module before it is digitally mixed with any sounds or sequences of sounds assigned to touch-sensitive sensors or tactile reception points at such times when those touch-sensitive sensors or tactile reception points receive tactile input.

Note that audio files of recorded music may refer to, without limitation: popular recorded music, background rhythms to help keep a beat, or music where the drum part has been removed. For music where the drum part has been removed, one or more touch-sensitive sensors or tactile reception points have a drum sound assigned to it and hence a user of the system can activate the one or more touch-sensitive sensors or tactile reception points with an associated drum sound in order to provide a source of drum sounds in the output audio signal.

In an embodiment, using instructions contained in the software application, a selected sound, a selected sound in a sequence, an entire sequence, a selected backing track, or the output audio signal may be processed with audio effects, and these audio effects may include, without limitation, reverb, delay, flange, chorus, compression, or distortion as well as changes to volume, panning, or pitch.

In an embodiment, using instructions contained in the software application, the output audio signal can be recorded as a recorded music audio file. Without limitation, the format of the recorded music audio file may be, without limitation, MPEG Audio Layer III (mp3) or Waveform Audio File Format (WAV) and it can be stored in any of: the memory module of the personal computing device, external media or an external memory module removably connected to the electronic interface or the personal computing device, or (if the personal computing device has the capability to connect to the internet) an internet accessible server. Using instructions contained in the software application, a user may choose to commence or conclude recording using the external user interface or the personal computing device's user interface. Furthermore, using instructions contained in the software application, a user may also choose to delete an unwanted output audio signal which was recorded and stored as an audio file using the external user interface or the personal computing device's user interface.

In such an embodiment, the selected audio file of recorded music from the memory module could be an audio file previously generated and recorded by the system, and hence, a user of the system can activate touch-sensitive sensors or tactile reception points to provide further instances of stored sounds in the output audio signal and thus add to the instances of stored sounds previously recorded by the system.

In an embodiment, the electronic interface includes an output display interface for displaying information to the user where such information might include, without limitation, information regarding whether a wireless connection is operational and/or whether or not a battery needs to be replaced or recharged, and the output display interface includes, without limitation, one or more LEDs, one or more LED displays, and/or one or more flexible displays.

In one such embodiment, the electronic interface is removably connectable to the personal computing device by means of a bi-directional communication channel and the electronic interface includes, without limitation, an output display interface and/or a vibration system. In this embodiment, the software application running on the personal computing device may produce, without limitation, display data to be displayed on a output display interface and/or commands for a vibration system to commence or cease vibrating. Using instructions contained in the software application, information passing from the personal computing device to the electronic interface over the bi-directional communication channel may include, without limitation, the display data to be displayed on the output display interface and/or the commands for the vibration system to commence or cease vibrating.

Without limitation, the bi-directional communication channel may be established by means of a wire, cable, or other direct electrical connection. Using instructions contained in the software application, the personal computing device's processor ensures proper display of any display data on the output display interface and/or ensures the appropriate behavior of the vibration system.

In the case of a personal computing device which contains, without limitation, a wireless receiver and a wireless transmitter, the electronic interface may include, without limitation, a wireless transmitter, a wireless receiver, a memory module, and a microcontroller. Using instructions contained in the software application, the bi-directional communication channel between the personal computing device and the electronic interface is established wirelessly between a.) the wireless transmitter of the electronic interface and the wireless receiver of the personal computing device and b.) the wireless transmitter of the personal computing device and a wireless receiver of the electronic interface. Using programming code stored in the electronic interface's memory module as guidance, the microcontroller: takes any display data received over the bi-directional communication channel and ensures its proper display on the output display interface and/or takes any commands for the vibration system to commence or cease vibrating and ensures the appropriate behavior of the vibration system. Note that, without limitation, the microcontroller can be replaced by a field-programmable gate array, a digital signal processor, a microprocessor, or a programmable intelligent computer.

Also provided herein is, using a personal computing device which includes: the personal computing device's user interface, a memory module for storing one or more musical or non-musical sounds, and a processor which can run a software application, a method for generating an output audio signal by accepting user input from an external user interface to be used by a software application running on a personal computing device. The method includes: a.) receiving from the user, the user input, using an external user interface designed to receive the user input, b.) relaying, by an electronic interface, electrically coupled to the external user interface and removably connectable to the personal computing device, information about the user input to the software application, c.) receiving the information about the user input, by the software application, and d.) generating the output audio signal, wherein the user interface and the electronic interface are each contained in one or more mounting structures, such that the output audio signal includes, at such times dictated by the user input received by the external user interface, one or more of the stored musical or non-musical sounds stored in the memory module.

In an embodiment, the software application running on the personal computing device may also accept input from one or more accelerometers and in some cases the user, external user interface, and personal computing device might be situated within a motor vehicle. In such cases, the software application running on the personal computing device can use input from the one or more accelerometers to help determine whether or not the motor vehicle is in motion, and, if the software application determines that the motor vehicle is in motion, the software application can temporarily cease to process input from user input information relayed by the electronic interface and/or user input information relayed from the personal computing device's user interface until such motion ceases.

In an embodiment, multiple instances of the system can be used concurrently. One external user interface may be the host external user interface, the electronic interface electrically coupled to this host external user interface as the host electronic interface, and the personal computing device receiving information about user input from this host electronic interface as the host personal computing device. This host personal computing device can include, without limitation, the host personal computing device's user interface, a host memory module for storing one or more musical or non-musical sounds, a host processor which can run a software application, and a wireless receiver, Each additional external user interface may be a client external user interface, each electronic interface electrically coupled to a client external user interface as a client electronic interface, and each personal computing device receiving information about user input from a client electronic interface as a client personal computing device. Each client personal computing device can include, without limitation, the client personal computing device's user interface, a client memory module for storing one or more musical or non-musical sounds, a client processor which can run a software application, and a wireless transmitter.

In such an embodiment, output audio signals can be generated using instructions contained in the software application running on the host processor and instructions contained in the software application running on each client processor. Each client personal computing device is removably connectable to the host personal computing device by means of a wireless connection such that: the wireless connection between each of the one or more client personal computing devices and the host personal computing device is established between the wireless transmitter of the client personal computing device and the wireless receiver of the host personal computing device.

In such an embodiment, the software application running on each client personal computing device has additional functionality in that, it is configured to send, using the wireless connection, client data to the software application running on the host personal computing device. Furthermore, the software application running on the host personal computing device has additional functionality in that, it is configured to receive, using the wireless connection, client data from each client personal computing device. The client data may contain, without limitation, information about user input received by the client external user interface or client personal computing device's user interface. As a result, the output audio signal from the host personal computing device additionally includes, at such times dictated by the user input received by the client external user interface or the client personal computing device's user interface, one or more of the stored musical or non-musical sounds stored in the host memory module.

Without limitation, transmission and receipt of wireless signals between the client personal computing devices and the host personal computing device are executed by means of one or more Bluetooth connections. Also without limitation, the host processor and each client processor can all be running instances of the same software application. Using an external user interface, a user selects whether this external user interface functions as a host external user interface or a client external user interface and the electronic interface relays information to the software application about what the user selects. The software application then ensures the personal computing device running the software application acts as a host personal computing device or client personal computing device as appropriate.

In one such embodiment, the client data may also contain information about which musical or non-musical sounds stored in the client memory module correspond to the user input received by this client external user interface or client personal computing device's user interface. In this way, the output audio signal from the host personal computing device might additionally include, at such times dictated by the user input received by the client external user interface or client personal computing device's user interface, one or more of the stored musical or non-musical sounds stored in the client memory module. In this embodiment, sounds, backing tracks, and saved recordings in the memory module of each client personal computing device may be accessed by the host personal computing device and selected for use in performances by the host external user interface.

In another such embodiment, a host external user interface and host personal computing device may be situated within one motor vehicle and a client external user interface and client personal computing device may be situated in a second motor vehicle.

In yet another such embodiment, each personal computing device might include, without limitation, a wireless receiver and a wireless transmitter. In this embodiment, the system uses instructions contained in the software application running on the host processor and instructions contained in the software application running on each client processor: In this embodiment, the wireless connection between each of the one or more client personal computing devices and the host personal computing device is a bi-directional communication channel established between a.) the wireless transmitter of the client personal computing device and the wireless receiver of the host personal computing device and b.) the wireless transmitter of the host personal computing device and the wireless receiver of the client personal computing device. The software application running on each client personal computing device is configured to receive host data from the software application running on the host personal computing device. Ultimately, sounds, backing tracks, and saved recordings in the memory module of the host personal computing device may be accessed by any client personal computing devices and selected for use in performances by any client external user interface.

In an embodiment, a microphone or electronic instrument may connect to any personal computing device in the system through a direct or wireless connection. Using instructions contained in the software application, the personal computing device includes the performance it receives from the microphone or electronic instrument in the output audio signal.

In an embodiment, a microphone or electronic instrument may connect to any personal computing device in the system through a direct or wireless connection, regardless of whether or not the personal computing device is a host personal computing device or a client personal computing device. Using instructions contained in the software application, the personal computing device removably connected to the microphone or electronic instrument includes the performance it receives from the microphone or electronic instrument in the output audio signal, and in the case of multiple personal computing devices, the output audio signal from all client personal computing devices are sent to the host personal computing device to be mixed together to produce the overall output audio signal for the entire system of host and client personal computing devices.

In summary, disclosed is a method and system describing an electronic musical instrument which outsources processing, memory, and audio output functions to a personal computing device such as a smart phone in order to achieve an electronic musical instrument with minimal hardware components, minimal cost, and potential for high portability. In an embodiment, the electronic musical instrument can be as small as an individual sensor which can be removably attached to any surface, although the technology is such that the instrument could be shaped in nearly any shape or size desired.

The user interface of the electronic musical instrument can be customized by a musician to produce the musical or non-musical sounds of his choosing without the need to buy expensive electronic hardware. New sounds are available nearly instantaneously and can be created by the user or downloaded from a library of sounds on the internet created by other users. Innovative options for performing with backing tracks, recording and sharing performances, and creating collaborative performances are also claimed.

It should be noted, that although the mounting structures 10 are described above as being mounted to a motor vehicle (e.g. to a steering wheel, dashboard, etc.) in some embodiments, the mounting structures 10 may be mounted to any type of motorized and/or non-motorized vehicle (e.g. car, truck, plane, helicopter, boat, Segway, bicycle, etc.). For example, the mounting structure could be mounted to the handlebars of a bicycle. The rider could control the music/sound application on their smartphone by triggering the touch sensors on the handlebars of the bicycle (i.e. the rider would not have to take their eyes off the road or their hands off the handlebars).

While specific embodiments of the present invention are shown and described above, further modifications and improvements will occur to those skilled in the art. While the foregoing written description of the invention enables one skilled in the art to make and use what is considered presently to be the best mode thereof, those skilled in the art will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Also, while the disclosure is presented in terms of embodiments, it should be appreciated that individual aspects of the disclosure can be separately claimed and any subset of these claims is also claimed.

I claim:

1. A mountable device for controlling a personal computing device to play a sound, the mountable device including:
a mounting structure;
a touch sensor on the surface of the mounting structure; and
a communication interface in the mounting structure which is electrically connected to the touch sensor,
wherein the communication interface is configured to transmit a message to the personal computing device in response to the touch sensor being triggered by a user, the message interpreted by a processor of the personal computing device to identify the triggered touch sensor and control a sound based software application on the personal computing device to play a predetermined sound associated with the triggered touch sensor.

2. The mountable device of claim 1,
wherein the communication interface makes use of at least one of Bluetooth, Near Field Communication (NFC), Zigbee, Ultra-Wide Band (UWB), 802.11, infrared, or ultrasonic communication technique or the personal computing device's audio jack to perform at least one of transmitting messages to the personal computing device and receiving messages from the personal computing device.

3. The mountable device of claim 1,
wherein the message includes at least one of a numerical value that identifies the triggered touch sensor and voltage information corresponding to a force applied to the touch sensor when it was triggered.

4. The mountable device of claim 1,
wherein the mountable device is mounted to at least one of an interior surface of a motor vehicle, a musical instrument, clothing, and a toy.

5. The mountable device of claim 1,
wherein the personal computing device includes at least one of a smartphone, a tablet computer, and a personal computer.

6. The mountable device of claim 1,
wherein the sound based software application allows the user to download sounds onto the personal computing device and associate the downloaded sounds to respective ones of the plurality of touch sensors of the mountable device.

7. The mountable device of claim 1,
wherein the sound based software application outputs the triggered sound through at least one of speakers internal to the personal computing device, speakers connected to the personal computing device, a motor vehicle sound system, and an instrument amplifier.

8. A mountable device mounted in a motor vehicle for controlling a personal computing device in or on the motor vehicle to play a sound, the mountable device including:
a mounting structure mounted to the motor vehicle;
a touch sensor on the surface of the mounting structure; and
a communication interface in the mounting structure which is electrically connected to the touch sensor,
wherein the communication interface is configured to transmit a message to the personal computing device in response to the touch sensor being triggered by a user, the message interpreted by a processor of the personal computing device to identify the triggered touch sensor and control a sound based software application on the personal computing device to play a predetermined sound associated with the triggered touch sensor.

9. The mountable device of claim 8,
wherein the communication interface makes use of at least one of Bluetooth, Near Field Communication (NFC), Zigbee, Ultra-Wide Band (UWB), 802.11, infrared, or ultrasonic communication techniques or the personal computing device's audio jack to perform at least one of transmitting messages to the personal computing device and receiving messages from the personal computing device.

10. The mountable device of claim 8,
wherein the message includes at least one of a numerical value that identifies the triggered touch sensor and a voltage information corresponding to a force applied to the touch sensor when it was triggered.

11. The mountable device of claim 8,
wherein the mountable device is mounted to at least one of a steering wheel cover, the dashboard of the motor vehicle, a door of the motor vehicle, a seat of the motor vehicle, and the center console of the motor vehicle.

12. The mountable device of claim 8,
wherein the personal computing device is at least one of a smartphone, a tablet computer, and a personal computer.

13. The mountable device of claim 8,
wherein the sound based software application allows the user to download sounds onto the personal computing device and associate the downloaded sounds to respective ones of a plurality of respective touch sensors of the mountable device.

14. The mountable device of claim 8,
wherein the sound based software application outputs the selected sound through at least one of speakers internal to the personal computing device, and a motor vehicle sound system.

15. A mountable device mounted on a musical instrument for controlling a personal computing device to play a sound, the mountable device including:
a mounting structure mounted to a surface of the musical instrument;
a touch sensor on the surface of the mounting structure; and
a communication interface in the mounting structure which is electrically connected to the touch sensor,
wherein the communication interface is configured to transmit a message to the personal computing device in response to the touch sensor being triggered by a user of the musical instrument, the message interpreted by a processor of the personal computing device to identify the triggered touch sensor and control a sound based software application on the personal computing device to play a predetermined sound associated with the triggered touch sensor.

16. The mountable device of claim 15,
wherein the wireless communication interface makes use of at least one of Bluetooth, Near Field Communication (NFC), Zigbee, Ultra-Wide Band (UWB), 802.11, infrared, or ultrasonic communication techniques or the personal computing device's audio jack to perform at least one of transmitting messages to the personal computing device and receiving messages from the personal computing device.

17. The mountable device of claim 15,
wherein the message includes at least one of a numerical value that identifies the triggered touch sensor and a voltage information corresponding to a force applied to the touch sensor when it was triggered.

18. The mountable device of claim 15,
wherein the mountable device is mounted to the musical instrument with at least one of adhesive and Velcro.

19. The mountable device of claim 15,
wherein the personal computing device is at least one of a smartphone, a tablet computer, and a personal computer.

20. The mountable device of claim 15,
wherein the sound based software application allows the user to download sounds onto the personal computing device and associate the downloaded sounds to respective ones of a plurality of respective touch sensors of the mountable device mounted to the musical instrument, and
wherein the sound based software application outputs the selected sound through at least one of speakers internal to the personal computing device, and an amplifier connected to the musical instrument.
